(19) United States
(12) Patent Application Publication
(10) Pub. No.: US 2007/0298246 A1
(43) Pub. Date: Dec. 27, 2007

(54) Corrosion-inhibiting coating for metal substrates and corrosion-resistant article

(75) Inventor: Jose Luis Martinez Carballido, Monterrey (MX)

Correspondence Address: REINHART BOERNER VAN DEUREN P.C., 2215 PERRYGREEN WAY, ROCKFORD, IL, 61107, US

(73) Assignee: Fabricas Monterrey, S.A. DE C.V., Monterrey (MX)

(21) Appl. No.: 11/821,264

(22) Filed: Jun. 22, 2007

(30) Foreign Application Priority Data
Jun. 26, 2006 (MX) NL/A/2006/000041

(51) Int. Cl. B32B 15/04; B05D 1/36; C04B 9/02

(52) U.S. Cl. 428/332; 106/14.05; 106/14.22; 106/14.44; 427/419.1; 428/457

(57) ABSTRACT

A corrosion inhibiting coating for metallic substrates, the corrosion inhibiting coating has an anticorrosive hydrophilic layer that includes at least a corrosion-inhibiting agent dispersed therein; and an impervious layer to oxygen and moisture over the hydrophilic layer. The anticorrosive hydrophilic layer is comprised of one or more water-soluble polymers such as, for example, polyvinyl pyrrolidone; one or more corrosion-inhibiting agents, such as, for example, salt of zinc and preferably zinc citrate; one or more cross-linking agents such as, for example, butanediol; and one or more solvents, such as, for example, water. Likewise, an article having anticorrosive function is provided, said article is comprised of a metallic substrate; an anticorrosive hydrophilic layer on the metallic substrate, such that the anticorrosive hydrophilic layer includes at least a corrosion-inhibiting agent dispersed therein; and an impervious layer to oxygen and moisture over said anticorrosive hydrophilic layer.

### CROSS-REFERENCE TO RELATED PATENT APPLICATIONS

This patent application claims the benefit of Mexican Application No. NL/a/2006/000041 filed Jun. 26, 2006, the disclosure and teachings of which are incorporated herein, in their entireties, by reference.

### FIELD OF THE INVENTION

The present invention refers to a corrosion-inhibiting coating applied to metal substrates. More specifically, it refers to a corrosion-inhibiting coating comprised of one or more anti-corrosive hydrophilic layers and one or more impervious layers to oxygen and moisture, such that the corrosion-inhibiting function of the anticorrosive hydrophilic layers acts when a portion of the metal substrate is exposed to corrosive conditions due to a fracture or removal of the impermeable layer.

### BACKGROUND OF THE INVENTION

Currently, most of the products, for instance, sheets, cans, containers and hermetic caps, are made of metallic substrates coated with coatings to delay or prevent the occurrence of rust on their surfaces. Exemplary coatings currently used on products with a metallic substrate can be found in the following patent documents.

Isao Ichinose et al., in Mexican patent MX-148954, refer to improvements in a coating for a hermetic cap consisting in a capsule shell having two components: a layer of priming material on its internal surface and a polyolefin coating applied in the interior of the capsule shell, characterized in that the layer of priming material in turn also consist of two components comprising a lower coating layer containing polyethylene oxide and an upper coating layer containing polyethylene oxide and at least other compatible resin with a layer for indicia printing being provided in the interface between the lower coating layer and the upper coating layer of the final coating layer.

Mitsuro Kato et al, in the Mexican patent MX-153545, describe an improved composition of vinyl chloride sol for container cap lining, wherein the composition comprises 100 parts by weight of vinyl chloride resin; from 50 parts to 100 parts by weight of a plasticizer selected from the group comprising of organic acid esters and epoxidic plastics; from 0.5 parts by weight to 10 parts by weight of a silicone oil having a viscosity in the range from 350 es to 100,000 es; from 0.5 parts by weight to 10 parts by weight of a lubricant selected from the group consisting of fatty acid amides, triglycerides, aliphatic alcohols and mixtures thereof.

Erich Kuehn, in Mexican patent MX-154100, discloses a coating composition for inhibiting corrosion of metallic surfaces, wherein the composition contains from 5% to 95% of supporting means selected from film-forming binding system and particulate substrates and from 5% to 95% of a substantially insoluble barium salt of organic compounds containing a carbonyl group, having from 2 to 40 carbon atoms and at least one acidic hydrogen atom, said compounds are selected from compounds having the following linkages: at least one hydroxyl group in a beta position relative to at least a carbonyl group, when they are separated by means of saturated carbon bonds; at least one hydroxyl group in the lambda position relative to at least one carbonyl group they when are separated by means of ethylenically unsaturated carbon bonds; and at least one hydroxyl group in the beta, delta or lambda positions relative to at least one carbonyl group, when they are separated by an aromatic instruction and wherein said carbonyl group is present as an aldo, keto, carboxyl, carboxy ester or amido group.

Charles Bromley and Morice William Thompson, in Mexican patent MX-156469, disclose an improved cross-linkable coating composition miscible in water in all proportions, characterized in that it consists of: (A) cross-linkable, water-insoluble, film-forming polymeric acrylic particles of a size of less than 10 microns which sterically stabilize in dispersion in a liquid mixture of: (B) at least one water soluble cross-linking agent for the film-forming polymer, with (C) at least one non-volatile, water-soluble substance having a molecular weight of less than 1000, which is able to participate in the reaction, whereby the film-forming polymer is cross-linked, but it does not substantially dissolves or swells the polymer particles; the amount of cross-linking agent (B) is up to 30 percent of the total weight of the constituents (A), (B) and (C); the amount of the non-volatile, reactive constituent (C) is from up to 40 percent of the total weight; and also being present a catalyst for the cross-linking reaction between constituents (A) and (B), in an amount from 0.1 to 2 percent by weight based on the total film-forming solids in the composition.

Alan James Bakhouse, in Mexican Patent MX-15764; discloses in improved procedure to obtain a protector and/or decorative multi-layer coating, on a surface of a substrate, comprising the steps of: (1) applying to the surface a base coating composition comprising (a) a film-forming material, (b) a volatile liquid medium for the material of (a), and (c) pigment particles dispersed in the liquid means; (2) forming a polymer film on the surface of the composition applied in step (1); (3) applying to the base coating film thus obtained, an upper coating composition comprising (d) a film-forming polymer and (e) a volatile carrier liquid for the polymer; and (4) forming a second film of polymer onto the base coating film of the base coating composition provided by means of a dispersion in a aqueous medium of crosslinked polymer microparticles mainly obtained from one or more alkyl ethers of acrylic acid or methacrylic acid having a diameter in a range from 0.02 microns to 10 microns, being insoluble in the aqueous medium and stable to flocculation, said dispersion has a pseudoplastic or thixotropic character; the base coating composition contains from 5% by weight to 80% by weight of polymer microparticles, based on the total content of non-volatiles of the composition, and from 2% by weight to 100% by weight of pigment particles based on the total content of non-volatile compounds of the composition.

David L. Forbes, in Mexican Patent MX-179165, describes an improved bottle filled with a drink and closed with a cap or crown comprising a top of a coating, where the improvement consist in that the coating is made of a thermoplastic polyurethane elastomer that has reacted.

Currently, the limitation exhibited by coatings for the metal substrates above disclosed, is that they only perform its protective, anticorrosive and aesthetic function as long as its mechanical integrity on the substrate is not altered, that is, as long as said coating remains on the substrate without being fractured, removed or scratched. Since, for example, the oxidation process, which occurs in the products made of metallic substrates, begins when the coating is detached from the substrate due, for instance, to the manufacturing, stacking, packing, operation and/or functioning process to which the product is subjected.

An example of the problem above disclosed is observed in the case of the manufacturing process of hermetic caps, commonly also referred to as crown, bottle top, screw caps or caps, which are made of a metallic sheet or plate upon which an ink, varnish and/or coatings such as the above described are applied, to proceed, thereafter, to a cut and printing process and finally to the addition of a plastic junction to form the internal seal of the hermetic cap. Before the application of the inks, varnishes and/or coatings, the metallic sheet or plate could have been treated with a galvanization, chrome-coating or tin-plating process intended to delay the corrosion thereof.

During the different steps of the cutting and printing process of the metallic sheet of plate to form the hermetic caps, a perimetral flange is created, the edge of which is without protection against corrosion, since said edge is not coated, such that when the hermetic cap is placed on the container nozzle, the perimetral flange of the hermetic cap is exposed to the conditions of the environment itself in which the containers of packed products are immersed.

When the hermetic cap is placed on the nozzle of the container and said cap is exposed to the conditions which initiate the phenomena of corrosion, the attack of the perimetral flange of the hermetic cap by said phenomenon is promoted, which occurs in the form of metallic oxide, that tends to deposit in the interior of the hermetic cap, as well as the upper flange of the container, such that when the hermetic cap is removed, to consume the product, the residues of oxide adhered to the perimeter of the nozzle create a bad appearance, as well as it can become a contamination source both for the packed product and for the consumer thereof.

Together with the above, the process itself of stacking and packing the product promote more detachments and/or scratches in the coating of the hermetic cap causing the occurrence of rust in exposed portions of the metallic substrate.

In light of the above disclosed and with the goal to offer a solution to the limitation found in the current coatings for metallic substrates, it is necessary to provide a coating whose protective, anti-corrosive and aesthetic function would be retained in spite that its mechanical integrity would be damaged once that said coating has been applied on the metallic substrate.

### SUMMARY OF THE INVENTION

In light of what has been described and with the purpose of resolve the drawbacks found, it is an object of the present invention to offer a corrosion-inhibiting coating for metallic substrates, the corrosion-inhibiting coating has an anticorrosive hydrophilic layer which includes at least one corrosion-inhibiting agent dispersed therein, and an impervious layer to oxygen and moisture disposed on said hydrophilic layer.

Together with the above, is an object of the present invention to offer a coating composition to form an anti-corrosive hydrophilic layer on a metallic substrate, the coating composition has at least one water soluble zinc salt; at least one water soluble polymer; at least one cross-linker; and water.

Finally, is an object of the invention to offer a method of forming a corrosion-inhibiting coating on metallic substrates, the method includes the steps of applying a coating composition to form an anti-corrosive hydrophilic layer on said metallic substrate; and applying a coating composition to form an impervious layer to oxygen and moisture on the hydrophilic layer formed.

### BRIEF DESCRIPTION OF THE DRAWINGS

The characteristic details of the invention are described in the following paragraphs along with the figures, which are intended to define the invention without limiting the scope thereof.

FIG. 1 shows a sectional view of an article having an anticorrosive function according to the invention.

FIG. 2 shows a sectional view of a corrosion-resistant article according to the invention, in which a fracture of the impervious layer and the functioning of the anti-corrosive hydrophilic layer are shown.

### DETAILED DESCRIPTION OF THE INVENTION

The term “article” is used according to the meaning of a metallic substrate coated with the corrosion-inhibiting coating of the present invention, such that said article can be present in the form of, for example, a laminated product, a laminated product employed in the manufacture of finished products by means of manufacturing processes such as cutting or printing; an hermetic cap, a can; a metallic container, among others.

The term “anticorrosive hydrophilic layer”, as used in the context of the present disclosure, means a coating layer, adherent to a substrate, which is made of one or several layers, which have the characteristic of absorbing water or swelling with water at normal temperatures and also of having the affinity of spreading and thereby diffuse a corrosion-inhibiting agent dispersed in said layer, on a substrate surface that is exposed.

The term “impervious layer” is used according to the meaning of a coating layer formed from one or several films, having the characteristic of being non-permeable to oxygen and moisture; decorative; impact resistant; adherent to the anticorrosive hydrophilic layer; and also of being the holding means for this layer and protective means for the substrate.

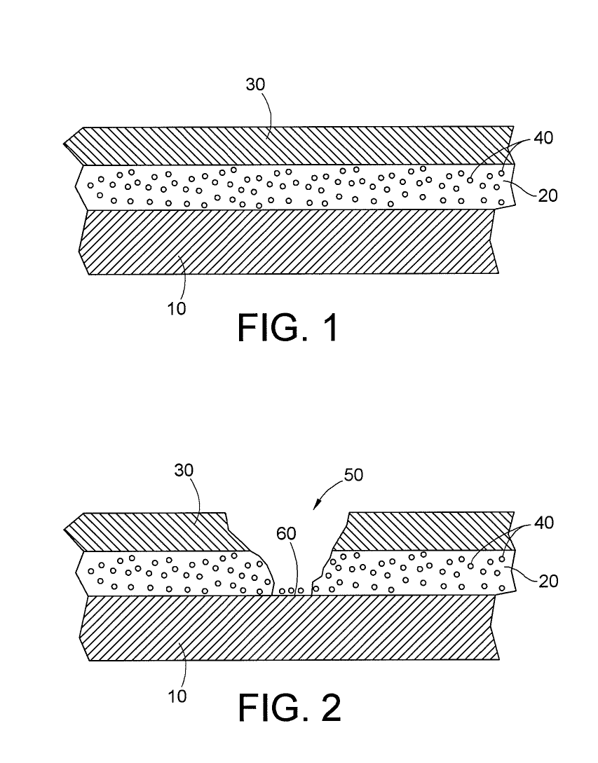

Referring to FIG. 1, a sectional view of an article with anticorrosive function according to the invention is illustrated. The article is comprised of a metallic substrate 10 coated with at least an anticorrosive hydrophilic layer 20 and at least one impervious layer 30. At least one corrosion-inhibiting agent 40 is dissolved in the anticorrosive hydrophilic layer 20.

The thickness of the anticorrosive hydrophilic layer generally is in a range of 3 μm to 200 μm. When the thickness of the anticorrosive hydrophilic layer is less than 3 μm, the desired ability of spreading and thereby diffuse the corrosion-inhibiting agent on the substrate surface that is exposed is not necessarily achieved; on the contrary, when the thickness is greater than 200 μm, defects in the formation and compatibility with the impervious layer or a decrease in the adhesiveness to the substrate.

The thickness of the impervious layer generally is in a range from 1 μm to 200 μm. When the thickness of the impervious layer is less than 1 μm, the desired ability of containing the anticorrosive hydrophilic layer and of resistance are not necessarily achieved; on the other hand, when the thickness is greater than 200 μm, defects in the formation of the hermetic cap can occur since a poor curing of the impervious layer is favored, whereby flexibility is lost, and therefore the formation of possible fractures or fissures in said layer.

I. Anticorrosive Hydrophilic Layer Composition

The present invention is not limited to a particular composition to form an hydrophilic layer on the surface of a metallic substrate, but preferably the use of a coating composition to form an hydrophilic layer of aqueous solution based on one or more water soluble polymers and one or more surfactants to maintain the solution it is suggested, such that the aqueous solution includes at least one dispersed corrosion-inhibiting agent in order to form the anti-corrosive hydrophilic layer. The anti-corrosive hydrophilic layer can be formed, on the metallic substrate, from a single layer or film, or formed through the repetitive application of two or more layers or films, which could have the same or different composition.

Water-Soluble Polymer

The water-soluble polymer, used in the composition of the anticorrosive hydrophilic layer, can be classified as natural, semi-synthetic and synthetic polymers. Examples of natural polymers include starch, gelatin, casein, and vegetable rubber, among others. Examples of semi-synthetic include cellulose derivatives such as, for example, methyl cellulose, ethyl cellulose, carboxymethyl cellulose, hydroxymethyl cellulose, among others. Examples of synthetic polymers include polymers of vinyl, such as, polyvinyl pyrrolidone, polyvinyl alcohol, polyvinyl methyl ether, hydroxyethyl methacrylate, acrylic acid, methacrylic acid and its derivatives, monomers with acrylic or methacrylic acid and its derivatives, among others.

In a preferred embodiment of the invention, out of the water soluble polymers described in the above paragraph, the use of polyvinyl pyrrolidone, in a range from 5% to 20% by weight relative to the anticorrosive hydrophilic layer composition to be applied, it is recommended.

Corrosion-Inhibiting Agent

Regarding the corrosion-inhibiting agent according to the invention, zinc compounds, preferably, both organic and inorganic zinc salts and their combinations are included, in particular, water soluble zinc salts such as zinc halides, zinc nitrates, zinc sulfates, zinc chromates, zinc silicates and complex compounds from this materials which constitute the salts of zinc contemplated in the invention. Included among the organic salts of zinc are, for example, zinc gluconate, zinc tartrate, zinc formate, zinc phenolsulfonate, zinc salicylate, zinc succinate, zinc glycerophosphate, zinc aspartate, zinc picolinate and other salts of zinc formed with amino acids, as well as their combinations Among the zinc halides are included, for example, zinc chloride, zinc bromide, zinc iodide, zinc fluoride and mixtures thereof.

Preferably, zinc citrate in a range from 1% by weight to 20% by weight relative to the anticorrosive hydrophilic layer composition to be applied, is used.

Cross-Linker

Among the typical examples of cross-linkers that can be used, butanediol, ethylene glycol, diethylene glycol, triethylene glycol, propylene glycol, polyethylene glycol, glycerin, trimethylol propane, penta-erythritol, polyoxyethylene glycol, polyoxypropylene glycol, polyoxyethylene-polyoxypropylene glycol among others, are included.

In a preferred embodiment of the invention, the use of butanediol in a range from 0.5% by weight to 5% by weight relative to the anticorrosive hydrophilic layer composition to be applied is recommended.

The Solvent

The coating composition to form the anti-corrosive hydrophilic layer is produced by properly dissolving or dispersing in water the components of the composition in order to form an aqueous solution.

In a preferred embodiment of the invention, a range from 40% by weight to 95% by weight of water is recommended, relative to the anticorrosive hydrophilic layer composition to be applied.

In an alternative embodiment of the invention, butyl-cellosolve, isopropyl alcohol or N-methyl pyrrolidone can be used as the solvent.

Other components

The coating composition to form the anticorrosive hydrophilic layer according to the present invention can contain in addition, if necessary or desired, catalyst such as, for example, phosphoric acid or para-toluenesulfonic acid in a range from up to 1% by weight relative to the final composition of the anticorrosive hydrophilic layer.

Mode of Preparation

The coating composition to form the anticorrosive hydrophilic layer is prepared by firstly dissolving in water the water-soluble polymer maintaining the solution in continuous stirring, next the surfactant is added to the aqueous solution with continuous stirring, and optionally the catalyst is added, obtaining thereby an aqueous solution commonly referred to as a resins solution.

Separately, the salt of zinc is dissolved in water in a suitable concentration, finally proceeding to mix the solution of zinc salt obtained with the resins solution until a homogeneous mixture is obtained.

Mode of Application

The anticorrosive hydrophilic layer can be applied, on the surface of a metallic substrate, by ordinary means of coating application, for example, by spraying, dipping, brushing, rolling, etc, followed by natural drying or thermal drying. The anticorrosive hydrophilic layer can be applied to the entire surface of the metallic substrate or, depending on the purposes, it can be partially applied to only one face or portion of the metallic substrate, for instance, in case that the coating is being applied to metallic hermetic caps for soft drink bottles, it can be applied preferably only to the inferior face of the hermetic cap.

II. Composition of the Impervious Layer

The present invention is not limited to a particular composition to form an impervious layer on the anticorrosive hydrophilic layer, but preferably the use of a conventional coating composition applicable to the decoration of metallic substrates is suggested, and the composition of which could be based on epoxy compounds, epoxy-esters, polyesters, vinyl compounds, acrylic compounds, polyurethanes, epoxy-phenol compounds or mixtures thereof.

Examples of coating compositions that can be used as the impervious layer in the present invention, can be found disclosed in the Japanese patent documents JP-2001019876, JP-2001019877, JP-2000290585, JP-11005942, JP-1278340, and in the Mexican patents MX-148964, MX-153545, MX-154100, MX-156469, MX-157641 y MX-179165.

The impervious layer can be formed, on the metallic substrate and/or anticorrosive hydrophilic layer, from a single layer or film, or it can be formed by the repetitive application of two or more layers or films, which could have the same or different composition.

Mode of Application

The impervious layer can be applied, on the surface of a metallic substrate and over the anticorrosive hydrophilic layer, by ordinary means of coating application, for example, by spraying, dipping, brushing, rolling, etc, followed by natural drying, thermal drying or by UV radiation.

Turning now to FIG. 2, a sectional view of an corrosion-resistant article according. to the invention is shown, in which the beginning of the function of the anticorrosive hydrophilic layer 20 is illustrated. Here is shown that the impervious layer 30 has suffered a fracture or fissure 50 due to handling conditions of the article itself, whereby part of the metallic substrate 10 is exposed to external conditions of corrosion. Is in this moment that the anticorrosive hydrophilic layer 20, due to its affinity to absorb moisture and to expand, begins to release and diffuse the corrosion-inhibiting agent 40 over the exposed portion of the metallic substrate 10. Thereafter, due to the solubility of corrosion-inhibiting agent 40 an anticorrosive and insoluble film 60 is formed on the exposed portion of metallic substrate 10.

### EXAMPLES

The invention will be explained in further detail through the following examples:

Metallic substrates, each formed from different MR type steel sheet (referred as sample 1, 2, 3 and 4) were degreased and prepared for the application of the corrosion-inhibiting coating of the present invention.

Each of the steel sheet (samples 1, 2, 3, and 4) was coated, immediately after, with an anticorrosive hydrophilic layer having the composition illustrated in Table 1, at a temperature of 20° C., following by drying at a temperature of 200° C. for 9 minutes.

TABLE 1

| Components | Sample 1 | Sample 2 | Sample 3 | Sample 4 |
|---|---|---|---|---|
| Polyvinyl pirrolidone | 5 | 10 | 15 | 20 |
| (% by weight) | | | | |
| Butanediol | 0.5 | 2 | 3.5 | 5 |
| (% by weight) | | | | |
| Zinc Citrate | 1 | 7 | 14 | 20 |
| (% by weight) | | | | |
| Water | 92.5 | 80 | 66.5 | 54 |
| (% by weight) | | | | |
| Phosphoric acid | 1 | 1 | 1 | 1 |
| (% by weight) | | | | |
| Thickness of the | 10 | 10 | 10 | 10 |
| anticorrosive | | | | |
| hydrophilic layer (μm) | | | | |

Subsequently, over the anticorrosive hydrophilic layer applied to each of the steel sheets (samples 1, 2, 3, and 4), an impervious layer having the composition illustrated in Table 2 is added, at a temperature of 20° C., following by drying at a temperature of 200° C. for 9 minutes.

TABLE 2

| Components | Sample 1 | Sample 2 | Sample 3 | Sample 4 |
|---|---|---|---|---|
| Phenolic resin | 10 | 15 | 20 | 25 |
| (% by weight) | | | | |
| Epoxy resin | 10 | 15 | 20 | 25 |
| (% by weight) | | | | |
| Vinyl resin | 5 | 10 | 15 | 20 |
| (% by weight) | | | | |
| Phosphoric acid | 1 | 2 | 3 | 5 |
| (% by weight) | | | | |
| Butyl-cellosolve | 74 | 58 | 42 | 25 |
| (% by weight) | | | | |
| Thickness of the | 20 | 20 | 20 | 20 |
| impervious layer | | | | |
| (μm) | | | | |

Subsequently, once that the steel sheets were coated with the corrosion-inhibiting coating of the invention, a series of controlled scratches was performed to said coating in each of the steel sheets in order to expose part of the metal substrate. After doing this, the steel sheets were subjected to an accelerated corrosion environment, proceeding to a continuous observation in order to detect the occurrence of rust visible to the naked eye. The obtained results are shown in Table 3.

TABLE 3

| | Samples having anticorrosive hydrophilic layer + | | | |
|---|---|---|---|---|
| | impervious layer according to Tables 1 and 2 | | | |
| | Sample 1 | Sample 2 | Sample 3 | Sample 4 |
| Required time for | 72 | 80 | 75 | 69 |
| the apparition of | | | | |
| visible oxide (hr) | | | | |

Based on the alternatives of composition above described, it is contemplated that the modifications to embodiments and compositions described, as well as the alternative embodiments of application and composition will be considered as obvious to one skilled in the art of the technique underlying the present disclosure. Therefore, it is contemplated that the claims encompass said modifications and alternatives that are within the scope of the present invention

What is claimed is:

1. A corrosion inhibiting coating for metallic substrates, wherein said corrosion-inhibiting coating comprises:
an anticorrosive hydrophilic layer which includes at least one corrosion-inhibiting agent dispersed therein, and
an impervious layer to oxygen and moisture disposed on said hydrophilic layer.

2. The corrosion inhibiting coating of claim 1, wherein said corrosion-inhibiting agent is one or more water soluble salts of zinc selected from the group consisting of zinc citrate, zinc chloride, zinc bromide, zinc iodide, zinc fluoride, zinc nitrate, zinc sulfate, zinc chromate, zinc silicate, zinc gluconate, zinc tartrate, zinc formate, zinc phenolsulfonate, zinc salicylate, zinc succinate, zinc glycerophosphate, zinc aspartate, zinc picolinate and mixtures thereof.

3. The corrosion inhibiting coating of claim 1, wherein said anticorrosive hydrophilic layer comprises:
at least one water soluble salt of zinc;
at least one water soluble polymer;
at least one cross-linking agent; and
at least one solvent.

4. The corrosion inhibiting coating of claim 1, wherein the salt of zinc is selected from the group consisting of zinc citrate, zinc chloride, zinc bromide, zinc iodide, zinc fluoride, zinc nitrate, zinc sulfate, zinc chromate, zinc silicate, zinc gluconate, zinc tartrate, zinc formate, zinc phenolsulfonate, zinc salicylate, zinc succinate, zinc glycerophosphate, zinc aspartate, zinc picolinate and mixtures thereof.

5. The corrosion inhibiting coating of claim 4, wherein the salt of zinc is zinc citrate within a range from 1% by weight to 20% by weight relative to the composition of said anticorrosive hydrophilic layer.

6. The corrosion inhibiting coating of claim 3, wherein the water-soluble polymer is selected from the group consisting of starch, gelatin, casein, vegetable rubber, methyl cellulose, ethyl cellulose, carboxymethyl cellulose, hydroxymethyl cellulose, polyvinyl pyrrolidone, polyvinyl alcohol, polyvinyl methyl ether, hydroxyethyl methacrylate, acrylic acid, methacrylic acid and its derivatives, monomers with acrylic or methacrylic acid and its derivatives and mixtures thereof.

7. The corrosion inhibiting coating of claim 6, wherein the water-soluble polymer is polyvinyl pyrrolidone within a range from 5% by weight to 20% by weight relative to the composition of said anticorrosive hydrophilic layer.

8. The corrosion inhibiting coating of claim 3, wherein the cross-linker is selected from the group consisting of butanediol, ethylene glycol, diethylene glycol, triethylene glycol, propylene glycol, polyethylene glycol, glycerin, trimethylol propane, penta-erythritol, polyoxyethylene glycol, polyoxypropylene glycol, polyoxyethylene-polyoxypropylene glycol and mixtures thereof.

9. The corrosion inhibiting coating of claim 8, wherein the cross-linker is butanediol within a range from 0.5% by weight to 5% by weight relative to the composition of said anticorrosive hydrophilic layer.

10. The corrosion inhibiting coating of claim 3, wherein the solvent is selected from the group consisting of water, butyl-cellosolve, isopropyl alcohol, N-methyl pyrrolidone and mixtures thereof.

11. The corrosion inhibiting coating of claim 10, wherein the solvent is water within a range from 40% by weight to 95% by weight relative to the composition of said anticorrosive hydrophilic layer.

12. The corrosion inhibiting coating of claim 3, wherein it also includes one or more catalysts.

13. The corrosion inhibiting coating of claim 12, wherein said catalyst is selected from the group consisting of phosphoric acid, p-toluenesulfonic acid and mixtures thereof within a range from up to 1% by weight relative to the composition of said anticorrosive hydrophilic layer.

14. The corrosion inhibiting coating of claim 1, wherein said anticorrosive hydrophilic layer has a thickness within a range from 3 μm to 200 μm.

15. The corrosion inhibiting coating of claim 1, wherein said impervious layer has a thickness within a range from 1 μm to 200 μm.

16. An article having anticorrosive function, wherein said article comprises:
a metallic substrate;
an anticorrosive hydrophilic layer on said metallic substrate, wherein said hydrophilic layer includes at least one corrosion-inhibiting agent dispersed therein, and
an impervious layer to oxygen and moisture disposed on said anticorrosive hydrophilic layer.

17. The article of claim 16, wherein said corrosion-inhibiting agent is one or more water soluble salts of zinc selected from the group consisting of zinc citrate, zinc chloride, zinc bromide, zinc iodide, zinc fluoride, zinc nitrate, zinc sulfate, zinc chromate, zinc silicate, zinc gluconate, zinc tartrate, zinc formate, zinc phenolsulfonate, zinc salicylate, zinc succinate, zinc glycerophosphate, zinc aspartate, zinc picolinate and mixtures thereof.

18. The article of claim 16, wherein said anticorrosive hydrophilic layer comprises:
at least one water soluble salt of zinc;
at least one water soluble polymer;
at least one cross-linking agent; and
at least one solvent.

19. The article of claim 18, wherein the salt of zinc is selected from the group consisting of zinc citrate, zinc chloride, zinc bromide, zinc iodide, zinc fluoride, zinc nitrate, zinc sulfate, zinc chromate, zinc silicate, zinc gluconate, zinc tartrate, zinc formate, zinc phenolsulfonate, zinc salicylate, zinc succinate, zinc glycerophosphate, zinc aspartate, zinc picolinate and mixtures thereof.

20. The article of claim 19, wherein the salt of zinc is zinc citrate within a range from 1% by weight to 20% by weight relative to the composition of said anticorrosive hydrophilic layer.

21. The article of claim 18, wherein the water-soluble polymer is selected from the group consisting of starch, gelatin, casein, vegetable rubber, methyl cellulose, ethyl cellulose, carboxymethyl cellulose, hydroxymethyl cellulose, polyvinyl pyrrolidone, polyvinyl alcohol, polyvinyl methyl ether, hydroxyethyl methacrylate, acrylic acid, methacrylic acid and its derivatives, monomers with acrylic or methacrylic acid and its derivatives and mixtures thereof.

22. The article of claim 21, wherein the water-soluble polymer is polyvinyl pyrrolidone within a range from 5% by weight to 20% by weight relative to the composition of said anticorrosive hydrophilic layer.

23. The article of claim 18, wherein the cross-linker is selected from the group consisting of butanediol, ethylene glycol, diethylene glycol, triethylene glycol, propylene glycol, polyethylene glycol, glycerin, trimethylol propane, penta-erythritol, polyoxyethylene glycol, polyoxypropylene glycol, polyoxyethylene-polyoxypropylene glycol and mixtures thereof.

24. The article of claim 23, wherein the cross-linker is butanediol within a range from 0.5% by weight to 5% by weight relative to the composition of said anticorrosive hydrophilic layer.

25. The article of claim 18, wherein the solvent is selected from the group consisting of water, butyl-cellosolve, isopropyl alcohol, N-methyl pyrrolidone and mixtures thereof.

26. The article of claim 25, wherein the solvent is water within a range from 40% by weight to 95% by weight relative to the composition of said anticorrosive hydrophilic layer to be applied.

27. The article of claim 18, wherein it also includes one or more catalysts.

28. The article of claim 27, wherein said catalyst is selected from the group consisting of phosphoric acid, p-toluene sulfonic acid and mixtures thereof within a range from up to 1% by weight relative to the composition of said anticorrosive hydrophilic layer.

29. The article of claim 16, wherein said anticorrosive hydrophilic layer has a thickness within a range from 3 μm to 200 μm.

30. The article of claim 16, wherein said impervious layer has a thickness within a range from 1 μm to 200 μm.

31. A coating composition to form an anticorrosive hydrophilic layer on a metallic substrate, wherein said coating composition comprises:
at least one water soluble salt of zinc;
at least one water soluble polymer;
at least one cross-linking agent; and
at least one solvent.

32. The coating composition of claim 31, where said salt of zinc is selected from the group consisting of zinc citrate, zinc chloride, zinc bromide, zinc iodide, zinc fluoride, zinc nitrate, zinc sulfate, zinc chromate, zinc silicate, zinc gluconate, zinc tartrate, zinc formate, zinc phenolsulfonate, zinc salicylate, zinc succinate, zinc glycerophosphate, zinc aspartate, zinc picolinate and mixtures thereof.

33. The coating composition of claim 32, where said salt of zinc is zinc citrate within a range from 1% by weight to 20% by weight relative to the coating composition.

34. The coating composition of claim 31, wherein the water-soluble polymer is selected from the group consisting of starch, gelatin, casein, vegetable rubber, methyl cellulose, ethyl cellulose, carboxymethyl cellulose, hydroxymethyl cellulose, polyvinyl pyrrolidone, polyvinyl alcohol, polyvinyl methyl ether, hydroxyethyl methacrylate, acrylic acid, methacrylic acid and its derivatives, monomers with acrylic or methacrylic acid and its derivatives and mixtures thereof.

35. The coating composition of claim 34, wherein the water-soluble polymer is polyvinyl pyrrolidone within a range from 5% by weight to 20% by weight relative to the coating composition.

36. The coating composition of claim 31, wherein the cross-linker is selected from the group consisting of butanediol, ethylene glycol, diethylene glycol, triethylene glycol, propylene glycol, polyethylene glycol, glycerin, trimethylol propane, penta-erythritol, polyoxyethylene glycol, polyoxypropylene glycol, polyoxyethylene-polyoxypropylene glycol and mixtures thereof.

37. The coating composition of claim 36, wherein the cross-linker is butanediol within a range from 0.5% by weight to 5% by weight relative to the coating composition.

38. The coating composition of claim 31, wherein the solvent is selected from the group consisting of water, butyl-cellosolve, isopropyl alcohol, N-methyl pyrrolidone and mixtures thereof.

39. The coating composition of claim 38, wherein the solvent is water within a range from 40% by weight to 95% by weight relative to the coating composition.

40. The coating composition of claim 31, wherein it also includes one or more catalysts.

41. The coating composition of claim 40, wherein said catalyst is selected from the group consisting of phosphoric acid, p-toluene sulfonic acid and mixtures thereof within a range from up to 1% by weight relative to the coating composition.

42. A method to form a corrosion inhibiting coating on metallic substrates, wherein the method comprises the steps of:
applying a coating composition to form an anti-corrosive hydrophilic layer on said metallic substrate; and
applying a coating composition to form an impervious layer to oxygen and moisture on the formed hydrophilic layer.

43. The method of claim 42, wherein said coating composition to form an anticorrosive hydrophilic layer on said metallic substrate comprises:
at least one water soluble salt of zinc;
at least one water soluble polymer;
at least one cross-linking agent; and
at least one solvent.

44. The method of claim 43, where said salt of zinc is selected from the group consisting of zinc citrate, zinc chloride, zinc bromide, zinc iodide, zinc fluoride, zinc nitrate, zinc sulfate, zinc chromate, zinc silicate, zinc gluconate, zinc tartrate, zinc formate, zinc phenolsulfonate, zinc salicylate, zinc succinate, zinc glycerophosphate, zinc aspartate, zinc picolinate and mixtures thereof.

45. The method of claim 44, where said salt of zinc is zinc citrate within a range from 1% by weight to 20% by weight relative to the coating composition.

46. The method of claim 43, wherein the water-soluble polymer is selected from the group consisting of starch, gelatin, casein, vegetable rubber, methyl cellulose, ethyl cellulose, carboxymethyl cellulose, hydroxymethyl cellulose, polyvinyl pyrrolidone, polyvinyl alcohol, polyvinyl methyl ether, hydroxyethyl methacrylate, acrylic acid, methacrylic acid and its derivatives, monomers with acrylic or methacrylic acid and its derivatives and mixtures thereof.

47. The method of claim 46, wherein the water-soluble polymer is polyvinyl pyrrolidone within a range from 5% by weight to 20% by weight relative to the coating composition.

48. The coating composition of claim 43, wherein the cross-linker is selected from the group consisting of butanediol, ethylene glycol, diethylene glycol, triethylene glycol, propylene glycol, polyethylene glycol, glycerin, trimethylol propane, penta-erythritol, polyoxyethylene glycol, polyoxypropylene glycol, polyoxyethylene-polyoxypropylene glycol and mixtures thereof.

49. The method of claim 48, wherein the cross-linker is butanediol within a range from 0.5% by weight to 5% by weight relative to the coating composition.

50. The method of claim 43, wherein the solvent is selected from the group consisting of water, butyl-cellosolve, isopropyl alcohol, N-methyl pyrrolidone and mixtures thereof.

51. The coating composition of claim 50, wherein the solvent is water within a range from 40% by weight to 95% by weight relative to the coating composition.

52. The method of claim 42, wherein said step of applying a coating composition to form an anticorrosive hydrophilic layer on said metallic substrate comprises the step of drying said anticorrosive hydrophilic layer.
